(19) United States
(12) Patent Application Publication
(10) Pub. No.: US 2005/0236603 A1
(43) Pub. Date: Oct. 27, 2005

(54) Conductive ink

(76) Inventor: Sadeg M. Faris, Pleasentville, NY (US)

Correspondence Address: REVEO, INC., 3 WESTCHESTER PLAZA, ELMSFORD, NY, 10523, US

(21) Appl. No.: 10/513,518

(22) PCT Filed: May 6, 2003
(86) PCT No.: PCT/US03/14144

§ 371 Date: Jun. 10, 2005

Related U.S. Application Data
(60) Provisional application No. 60/380,048, filed on May 7, 2002.

(51) Int. Cl. H01B 1/00

(52) U.S. Cl. 252/500

(57) ABSTRACT

Transparent conductive inks are provided. The conductive ink generally comprises flakes of electrically conductive material mixed with an ink carrier material. This invention shows that by making electrically conductive materials into pre-annealed flat flakes or platelets and mixing them in a suitable fluid, the prior art problems are solved, making it possible for electrically conductive inks to be conveniently used for general purpose applications exploiting their remarkable conductive properties. This is an electrically conductive ink, which is applied at room temperature, and no further annealing or treatment by the user is needed, since the conductive platelets are already annealed.

### BACKGROUND OF THE INVENTION

1. Field of the Invention

The present invention relates to conductive ink materials, particularly transparent conductive ink materials and applications of such transparent conductive ink materials.

2. Description of the Prior Art

Conductive ink materials have been known for some time, and have been used in applications such as printing patterned circuit boards, forming conductive films, and other application specific uses, such as printing antennas.

Matsushita U.S. Pat. No. 5,174,925 discloses a thick film for circuit boards. The thick film is formed by a conductive ink composition including conductive metal powder, glass frit, a transition metal oxide, a disbursing agent and a vehicle including an organic binder. However, the materials disclosed must be formed into patterns by filling grooves of an indiglio with the conductive ink, and transferring the ink first to a blanket having elastic material, and then to the circuit board, followed by baking of the ink onto the circuit boards.

Merck U.S. Pat. No. 6,162,374 discloses a pigment mixture including silicon oxide flakes coated with a metal oxide material, as a nonconductive component, and electrically conductive pigment materials as an electrically conductive component. This patent is apparently based on an a discovery that inclusion of electrically nonconductive silicon oxide flakes in combination with electrically conductive pigments have better conducive properties than the conductive pigment alone.

Dai Nippon U.S. Pat. No. 6,084,007 discloses a transparent conductive ink for forming a transparent conductive film by gravure printing on the surface of multicolored picture patterns produced by offset printing. The conductive ink includes a thermoplastic resin and very fine (<1 micrometer) powder material, and a solvent.

Soliac U.S. Pat. No. 5,639,556 discloses a conductive ink for circuit junctions. The conductive ink has metal particles with different melting temperatures, such that upon heating of the material, lower melting temperatures metal particles melt and achieve a conductive connection.

Paramount Packaging Corp. U.S. Pat. No. 5,763,058 discloses articles using electrically conductive liquids printed on a substrate. A process is disclosed whereby electrically conductive pathways can be deposited continuously on a substrate. However, the conductive inks taught therein include conductive powders of aluminum, graphite, gold, silver, and carbon. All of these conductive inks provide opaque print lines.

Key-Tech Inc. U.S. Pat. No. 5,093,038 discloses silver coated magnetite particles and an epoxy resin binder and a photo initiator. Upon ultraviolet curing of the material, silver coated magnetite particles generally move to the top surface of the cured material, forming an electrically conductive region.

Paramount Packaging Products discloses directly printing a conductive ink onto flexible substrates. However, this disclosure fails to teach or disclose how to form transparent conductive inks, and applications using transparent conductive inks. The primary disadvantage of conventionally known conductive inks is the lack of transparency. Therefore, any pattern formed with a conductive ink are visible, thus preventing usage in transparent materials, and further detracting from aesthetic appeal in other flexible or rigid substrates.

Transparent conductive films have been known for some time, and have been used in applications such as electric shielding and actuatable displays, such as flat-panel displays. For example, Sumitomo U.S. Pat. Nos. 4,594,182, 4,619,704, 5,853,869, 5,849,221, 6,051,166, 5,785,897, 5,763,091, 5,662,962, and 5,421,926 disclose various electrically conductive films and materials for electrically conductive films, mainly based on indium tin oxide. Some of these patents (e.g., U.S. Pat. Nos. 5,662,962 and 5,421,926) disclose methods of making electroconductive substrates using indium tin oxide based conductive inks. In general, indium tin oxide powder and is mixed with the carrier material and cured to a suitable rigidity for the desired application.

Unfortunately, the conductive inks used to forming the transparent electrically conductive films must be cured and/or annealed in order to provide the desired electrical conductivity to form the conductive film. Therefore, is not practical or desirable to use the inks disclosed in the Sumitomo patents to directly print an electrically conductive pattern, for example, as disclosed in the patent assigned to Paramount Packaging Products. Since the conductive inks disclosed in the Sumitomo patents require curing and/or annealing, application on flexible substrates, which may not be able to withstand the extreme temperatures in the curing and/or annealing steps, is not possible.

Therefore, it is desirable to provide an electrically conductive transparent ink material which may be printed directly on a substrate and which further obviates that need for subsequent curing and/or annealing.

### SUMMARY OF THE INVENTION

The above-discussed and other problems and deficiencies of the prior art are overcome or alleviated by the several methods and apparatus of the present invention for forming conductive inks, preferably transparent conductive inks. The conductive ink generally comprises flakes of electrically conductive material mixed with an ink carrier material.

This invention shows that by making electrically conductive materials into pre-annealed flat flakes or platelets and mixing them in a suitable fluid, the prior art problems are solved, making it possible for electrically conductive inks to be conveniently used for general purpose applications exploiting their remarkable conductive properties. This is an electrically conductive ink, which is applied at room temperature, and no further annealing or treatment by the user is needed, since the conductive platelets are already annealed.

The principal object of the present invention is to provide a method for producing electrically conductive flat flakes or platelets.

Another object of the present invention is to provide a method for producing transparent electrically conductive flat flakes or platelets.

Another object of this invention is to make electrically conductive inks which can be applied at room temperature and after drying, retain their remarkable color effects.

Another object of this invention is to make transparent electrically conductive inks which can be applied at room temperature and after drying, retain their remarkable color effects.

Another object of this invention is to provide low cost articles having printed electrically conductive ink patterns thereon.

Yet another object of this invention is to provide novel pens, pencils, and crayons for electrically conductive printing applications.

The above-discussed objects and other features and advantages of the present invention will be appreciated and understood by those skilled in the art from the following detailed description and drawings.

### BRIEF DESCRIPTION OF THE DRAWINGS

FIG. 1 shows platelets of electrically conducting material; and

FIGS. 2A-2C show exemplary manufacturing systems and processes.

### DETAILED DESCRIPTION OF THE ILLUSTRATIVE EMBODIMENTS

Herein disclosed is a composition for forming transparent conductive inks. The transparent conductive ink generally comprises flakes of electrically conductive material mixed with a transparent ink resin material.

The electrically conductive materials generally comprise indium tin oxide, zinc oxide, doped zinc oxide, other types of doped tin oxide, or any combination comprising at least one of the foregoing oxides. A common property of these electrically conductive materials is the optical transparency. Alternatively, translucent or opaque materials may be used, alone or in combination with the transparent materials, when optical transparency is not absolutely required (e.g., when the conductive ink is to be used on a dark colored substrate, similar color materials may be used).

As is conventionally known in the field of producing conductive films, these electrically conductive materials may be provided (as a precursor to the flakes formed herein) in the form of fine powders. These powders are mixed with suitable carrier precursors and/or solvents, if necessary, and are deposited or otherwise applied to a substrate to form a film. The end product of typical conducting films may be provided on the substrate or removed from the substrate.

Flakes of electrically conductive materials are generally formed according to the following procedure: electrically conductive precursor materials (and any necessary carrier precursor) are deposited on a support substrate; the materials on the substrate are annealed to form a coherent film structure; the resultant conductive film is removed from the substrate; ball milling and other known techniques are used to turn the film into platelets. According to this general process, the substrate need not be transparent to produce transparent flakes (when the electrically conductive precursor materials (and any necessary carrier precursor) are transparent).

Alternatively, the resultant conductive film may remain on the substrate, and processed into platelets with the substrate intact. According to this general process, to produce transparent flakes (when the electrically conductive precursor materials (and any necessary carrier precursor) are transparent), the substrate may comprise a transparent substrate such as glass, polycarbonate sheets, acrylic sheets, and other plastics. For example, polyethylene terephthalate (PET) may be used as substrate materials for the growth of transparent conducting oxide thin films.

The materials may be deposited by a variety of techniques, including, but not limited to, electron beam deposition; reactive evaporation at an elevated substrate temperature (e.g., 100-200° C.); DC magnetron sputtering (e.g., on PET substrate) followed by annealing; RF sputtering; pulsed laser deposition; or any combination comprising at least one of the foregoing techniques. By these and other methods, the oxide layer may be on the order of 100s Å to several microns, depending on the desired properties of the conductive.

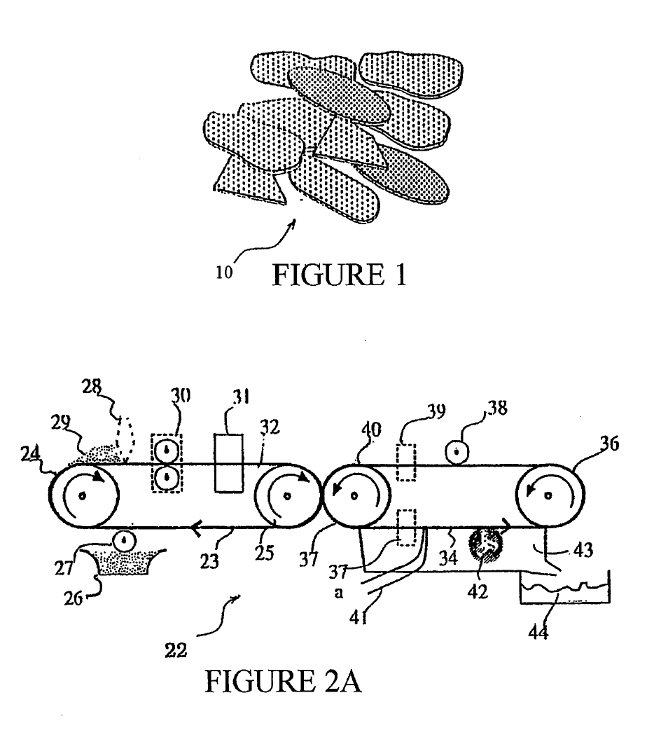

FIG. 1 illustrates typical conductive flakes or platelets shapes 10. They can have regular or irregular geometrical shapes, with the average lateral dimension typically more than 3 times the thickness. Platelets 10 could have average lateral dimensions are in the 4 to 100 microns range, and average thicknesses in the 2 to 10 microns range.

These platelets 10 are mixed in a suitable carrier fluid producing a conductive ink which is then used in printing applications. These conductive inks are applied at room temperature and do not need further curing or annealing by the user, other than normal room temperature drying of ink based applications.

The conductive ink according to this invention comprises the conductive flakes or platelets and a suitable carrier material. The carrier material is well known in the ink art (see, e.g., Chapter 18, p 523 in J. Michael Adams, Printing Technology, 3rd Ed., Delmar Publishers, Inc., Albany, N.Y., 1988) and is selected depending on the applications. It further comprises vehicles and additives chosen for tackiness, drying speed, adhesion to substrates, printing or painting methods, and other properties.

In certain preferred embodiments, The carrier comprises an adhesive that has electrical conductivity properties, such as polyaniline, doped PVA, or other electrically conducting polymer.

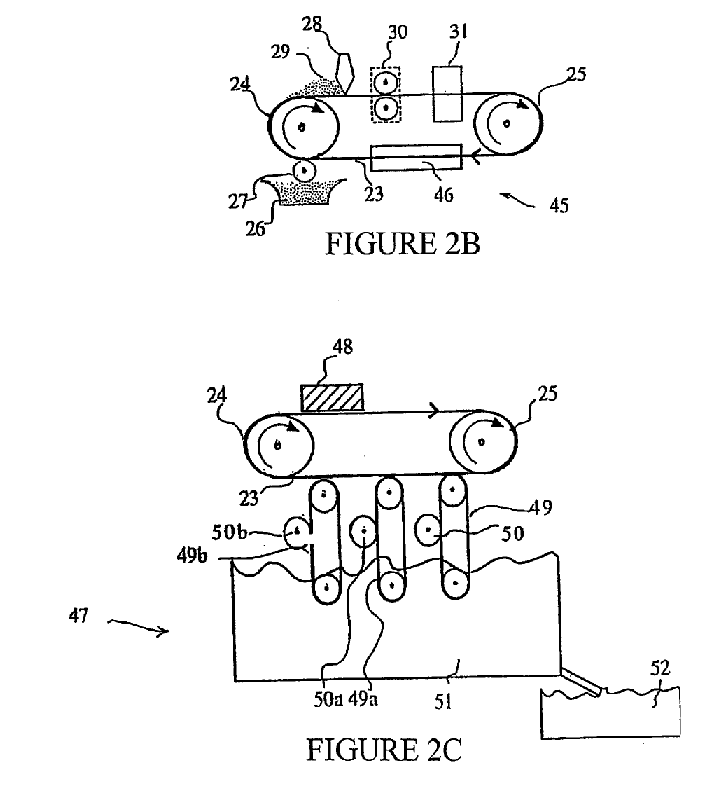

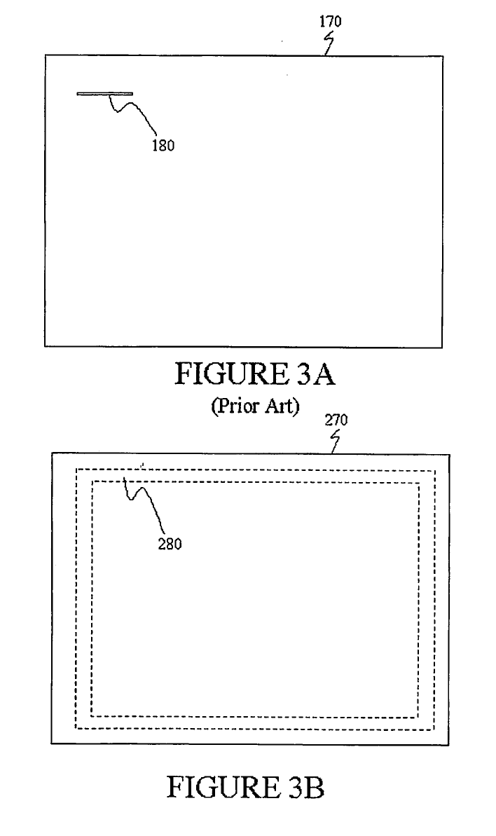

FIGS. 2A-2C describe methods and apparatuses used for high throughput economical manufacturing of electrically conductive platelets. Apparatus 22 in FIG. 2A comprises a first belt 32 rotated continuously by means of rotating drums 24, 25, and a second belt 34 rotated by drums 36, 37 in the opposite direction of first belt 32. The first belt 32 carries the conductive precursor composition formed into a film, while the second belt 34 is allowed to press against the first belt in order to remove the conductive film by adhesive means. This process of coating and removal of the conductive precursor composition formed into a film and the production of the final product, the platelets or flakes, is carried out continuously according to the following steps:

1. The starting conductive precursor composition in a molten state in a container 26 is coated onto belt 23 by means of a roller 27 (other coating means such as spraying, casting, chemical vapor deposition, laser vapor deposition, sputtering, and reaction evaporation are possible).

2. While the coated belt is in motion, a knife edge device 28 may optionally be used (as indicated by dashed lines) to smooth the film of conductive precursor composition and maintain a uniform and repeatable thickness. The excess conductive precursor material 29 is recycled.

3. The conductive film then passes through an auxiliary curing step 30 (if necessary) which applies, for example, heat and/or ultraviolet radiation to the film.

4. If a polymeric carrier is utilized in the conductive precursor composition, the above steps may be carried out above the glass temperature of the polymer precursor.

5. The conductive film then passes through a drying and cooling chamber 31 and the desired conductive film 32 below the glass temperature is brittle and can be transferred adhesively by the second belt 34.

6. The second belt 34, rotating in the opposite direction of first belt, is coated by means of a roller 38 (spraying or other well-known means may be used) with an adhesive. Said adhesive passes through chamber 39 for drying and maintaining an optimum operating temperature, and other adhesive properties. The adhesive could be water soluble polyvinyl alcohol or other adhesives which can be dissolved in suitable low cost solvents that have minimum environmental impact. Some adhesive may be chosen to be brittle when dry. For transparent conductive materials, transparent adhesives are utilized.

7. The optimized adhesive coating 40 is pressed by means of drum 37 onto conductive film 32 on drum 25. This action transfers the conductive film from belt 23 to belt 34. The system is preferably optimized such that the conductive film forms small platelets or flakes upon transfer.

8. The transferred conductive material on the adhesive is passed through a cooler 37a which cools the combined coating to low enough temperature to ensure the brittleness of both conductive coating and the adhesive coating. By cooling to cryogenic temperature such as that of liquid carbon dioxide or liquid nitrogen, the conductive coating and the adhesive coating become brittle.

9. The brittle conductive and adhesive coatings are removed by means of an ultrasonic air jet 41 or an air jet mixed with fine powder abrasive. The conductive and adhesive coatings that is not removed by the ultrasonic means is scrubbed off by means of a scrubber 42. The flakes of conductive film are collected in a container 43 and are poured into container 44.

10. The conductive material on adhesive mixture is further broken into the desired average flake or platelet size. The adhesive is subsequently dissolved off and separated from the conductive flakes—which are dried and mixed with the appropriate fluid to produce conductive ink.

11. The process steps 1-10 for producing conductive flakes are repeated continuously as belts 23 and 34 continue to counter rotate.

FIG. 2B shows another embodiment 45 for producing conductive flakes that uses only a single belt. The embrittled conductive film passes through an ultrasonic bath 46 which imparts intense ultrasonic energy to the conductive film causing it to flake-off.

Yet another embodiment 47 for producing conductive platelets and simultaneously produce the final conductive ink (with minimum steps) is shown in FIG. 2C, comprising: a belt 23; two drums 24, 25; a means 48 for coating conductive films; and a means for transferring said films. The transfer means further comprises one or more transfer belts 49, 49a, 49b, coated respectively with adhesives by means of rollers 50,50a,50b. The rollers 50, 50a, 50b coat each of their respective belts with a random adhesive pattern. These patterns are designed to transfer conductive flakes with a predetermined average size. The belts 49, 49a, 49b are immersed in solvent container 51 which dissolves off the adhesive and precipitates the flakes with a predetermined average size that are ready for use in inks. In this case the solvent may be the appropriate fluid needed for the final conductive ink product.

Many skilled in the art will be able to find other variations of producing conductive flakes and/or inks without departing significantly from the basic teachings of this invention. For instance, if the conductive film is not brittle, it is still possible to use it for producing platelets by well known patterning and etching means. In this case photo-resist or etch resist patterns are generated which serve to protect the desired platelets regions, and the exposed regions are etched away by a suitable wet or dry etching means. This would produce the desired platelet size and shape.

Other Exemplary Ink Constituents

Water-Based Ink-Jet Ink Composition

| | | Approximate |
|---|---|---|
| Component | Function | Concentration, % |
| Deionized water | Aqueous carrier medium | 60-90 |
| Water soluble solvent | Humectant, viscosity control | 5-30 |
| [Transparent]¹ | Electrical conductivity | 1-10 |
| conductive flakes | | |
| Surfactant | Wetting, penetrating | 0.1-10 |
| Biocide | Prevents biological growth | 0.05-1 |
| Buffer | Controls the pH of ink | 0.1-0.5 |
| Other additives | Chelating agent, defoamer, | >1 |
| | solublizer etc. | |

¹“Transparent” is in brackets, as optionally, translucent or opaque inks may also be formulated according to the teachings of the present invention.

Phase-change Ink Composition

| | | Approximate |
|---|---|---|
| Component | Function | Concentration, % |
| Solid wax mixture | Ink vehicle | 40 to 70 |
| Viscosity modifier | Lowers viscosity | 5 to 20 |
| Tackifier | Imparts adhesion | 1 to 15 |
| Plasticizer | Provides flexibility | 1 to 15 |
| Transparent]² | Electrical conductivity | 1 to 10 |
| conductive flakes | | |
| Antioxidant | Heat stability | 0.05 to 2 |

²“Transparent” is in brackets, as optionally, translucent or opaque inks may also be formulated according to the teachings of the present invention.

Applications of Conductive Inks

The conductive inks produced based on the teachings of this invention can be used in the electronics arts where transparency is desired, security markings, antennae, windows (e.g., residential, commercial, transportation), toys, sporting goods, and many more. Unlike prior art, these conductive inks can be dispensed by well known means at room temperature and without the need for further curing, annealing, or other treatment (other than normal drying such as is common in conventional dye based non-conductive inks). In the conductive ink, the conductive flakes are suspended in a host fluid or a host matrix depend on the printing or imaging application. In a crayon or a pencil form, the host matrix could be a wax or an equivalent sticky material that is solid state at room temperature. The conductive inks could be dispensed from a pen for drawing, paining, plotting, and writing. The ink could be applied by means of a brush, roller, or spray gun. The ink could also be formulated for use in off-set printing wherein the host fluid is made hydrophobic, or in gravure and flexographic printing wherein the host fluid is formulated for printing on plastic substrates, or other substrates. The conductive inks may also be used as a toner in electrographic copier and printers (based on xerography process) or thermal printers. Further, the conductive inks may used in inkjet printers.

Antennas (e.g., for smart cards and RF tags) may be formed by print the transparent conductive ink by conventional means on to any surface to create a pattern for the antenna. In one preferred embodiment, the RF tags and smart cards have a chip that does not require external power sources, whereby the antenna receives sufficient power signal to activate the chip. In other preferred embodiments, a single transparent antenna transmits information and receives signals (e.g., for interrogation to determine identity of an article).

On-board chips may be manufactured by known semiconductor manufacturing, or alternatively using a manufacturing technique taught by the co-inventor herein entitled “Thin films and Production Methods Thereof”, U.S. application Ser. No. 09/950,909 filed on Sep. 12, 2001, the entire disclosure of which is hereby incorporated by reference.

With conventional non-transparent inks using conductive carbon, for example (which is black), printed conductors such as antennas remain visibly obtrusive, thus are typically printed very small for aesthetic purposes (e.g., less than an inch), as shown schematically in FIG. 3A with a conventional antenna 180 on an article 170. Accordingly, range is also small, and limits the capability of the article containing the printed conductors such as antennas. By using transparent conductive inks, as compared to conventional carbon based inks, the constraint of the antenna size may be removed, and relatively large printed conductors such as antennas may be formed (e.g., circumferentially surrounding a valuable documents, currency, securities, notes, identification card, passport, licenses such as aviation and motor vehicle, or other articles), as shown schematically in FIG. 3B with an antenna 280 on an article 270.

In another application, the transparent conductive ink may be used on tags for articles for purchase, for example, in a retail or wholesale environment. The RF tag may be discretely located on or in the article, and the transparent conductive ink may be used to provide an integral antenna, for example, directly on the article or article packaging.

In another application of the present transparent conductive ink, transparent antenna may be readily formed on existing windows (after or prior to installation). Alternatively, a step of printing transparent antennas in existing window manufacturing processes may easily be added. This will allow efficient transmission and reception of signals such as wireless devices including telephones and GPS devices.

Uses of invisible antennae on glass windows may be particularly desirable to set up a repeater system. Repeater systems can be very useful to enhance reception indoors of various transmissions such as GPS signals, satellite transmissions, cellular phone transmissions, radio transmission or any RF transmission.

In further embodiments, invisible antennae can be connected to a power source, wherein the power source connection may be by conventional conductors or by an invisible conductor, generally for the purpose of enhancing signal reception. The power source may be self-contained power sources such as batteries or alternatively may be connected to typical building power sources.

A plurality of invisible antennae can be interconnected (with conventional conductors or with invisible conductors described herein) to form a network of invisible antennae, allowing for efficient signal transmission within a building that otherwise would lack clarity of signal reception.

While preferred embodiments have been shown and described, various modifications and substitutions may be made thereto without departing from the spirit and scope of the invention. Accordingly, it is to be understood that the present invention has been described by way of illustrations and not limitation.

1. A method of making electrically conductive transparent ink comprising
providing a transparent conductive rigid film;
transforming said electrically conductive transparent film into a plurality of electrically conductive transparent flakes;
mixing said electrically conductive transparent flakes with a transparent ink carrier material.

2. The method as in claim 1, where the electrically conductive transparent film is formed by sputtering or chemical vapor deposition of a transparent electrically conductive material coating on a substrate.

3. The method as in claim 2, wherein the substrate and the coating are used to form the flakes.

4. The method is in claim 2, wherein the coating is removed from the substrate, further wherein the flakes are formed from the coating without the substrate

5. A transparent conductive ink comprising:
transparent conductive flakes; and
transparent ink carrier material.

6. A substantially transparent conductive ink comprising:
substantially transparent conductive flakes; and
substantially transparent ink carrier material.

7. Apparatus for producing conductive platelets comprising:
a container and a means for producing a conductive precursor material;
a film application device;
a first substrate coated by said film application device with a film of said conductive precursor material;
an annealing apparatus to anneal the conductive precursor material into the desired electrical resistivity;
a drying and cooling means for producing a conductive film;
a second substrate coated with an adhesive by an adhesive application device;
said adhesive, after application to said second substrate, is dried by a drying apparatus;
a device for transferring conductive film from first substrate onto adhesive coated second substrate;
a means for embrittling said conductive film and said adhesive;
a means for breaking into small platelets and removing the brittle conductive film and adhesive from second substrate;
a means for separating the conductive platelets from the adhesive; and
a means for drying the conductive platelets, and breaking them further into smaller platelets.

8. Apparatus for producing conductive platelets according to claim 7, wherein first and second substrates are continuously counter rotating belts rotated by drums, said belts are continuously touching to transfer conductive film.

9. Apparatus for producing conductive platelets according to claim 7, wherein the embrittling means is a chamber for cooling the materials to cryogenic temperature where nearly all conductive precursor materials become brittle and easily broken into platelets.

10. Apparatus for producing conductive platelets according to claim 7, wherein the means for breaking and removing the brittle conductive film and adhesive is an ultrasonic air jet, water jet, or a jet of a slurry comprising a fluid and an abrasive powder.

11. Apparatus for producing conductive platelets according to claim 7, wherein the means for separating the conductive platelets from the adhesive is dissolving the adhesive in suitable solvents.

12. Apparatus for producing conductive platelets according to claim 7, wherein the second substrate is eliminated, and the conductive film is broken into platelets and removed directly from the first substrate by means of an ultrasonic bath.

13. Apparatus for producing conductive platelets according to claim 7, wherein the means for breaking and removing the brittle conductive film and adhesive is a vacuum means for applying suction to said film.

14. Apparatus for producing conductive ink comprising:
a continuously moving substrate;
a means for coating said substrate with a conductive film;
a means for removing the conductive film in the form of small conductive platelets; and
a means for mixing a suitable host material with said conductive platelets producing the final conductive ink product.

15. Apparatus for producing conductive ink according to claim 14, wherein the means for removing the conductive film from substrate is a plurality of belts each coated with an adhesive pattern of the desired platelet size such that all the conductive film is turned into platelets.

16. Apparatus for producing conductive ink according to claim 14, wherein the means for separating the conductive platelets from the adhesive is the same fluid desired for making the final conductive ink product.

17. A process for producing conductive platelets comprising the steps of:
a. coating a first substrate with conductive precursor material,
b. treating said conductive precursor material to provide a conductive film of uniform thickness;
c. transferring said conductive film to a second substrate, said second substrate having an adhesive coating on a surface thereof forming a conductive film-adhesive coating structure,
d. breaking said conductive film and said adhesive coating structure into adhesive coated platelets of a selected size,
e. separating said adhesive coating from said adhesive coated platelets by means of a solvent, and,
f. drying said platelets.

18. A process for producing conductive platelets according to claim 17 wherein the step of treating includes the step of annealing said conductive precursor material to form a film of a desired electrical resistivity.

19. A process for producing conductive platelets according to claim 17 further including the step of mixing said platelets into a host material.

20. A process for producing conductive platelets comprising the steps of:
a. coating a first substrate with conductive precursor material,
b. treating said conductive precursor material to provide a conductive film of uniform thickness;
c. transferring said conductive film to a second substrate, said second substrate having an adhesive coating on a surface thereof forming a conductive film-adhesive coating structure,
d. shaping at least said conductive film into adhesive coated platelets of a selected size,
e. separating said adhesive coating from said adhesive coated platelets by means of a solvent, and,
f. drying said platelets.

21. A process according to claim 20 wherein the step of shaping at least said conductive film includes the steps of photolithographically patterning and etching said at least a layer into platelets of a selected size.
